(19) United States
(12) Patent Application Publication
(10) Pub. No.: US 2022/0390875 A1
(43) Pub. Date: Dec. 8, 2022

(54) CARRIER FOR DEVELOPING ELECTROSTATIC IMAGE, ELECTROSTATIC IMAGE DEVELOPER, AND IMAGE FORMING METHOD

(71) Applicant: FUJIFILM Business Innovation Corp., Tokyo (JP)

(72) Inventors: Shintaro ANNO, Kanagawa (JP); Yosuke Tsurumi, Kanagawa (JP); Takeshi Tanabe, Kanagawa (JP)

(73) Assignee: FUJIFILM Business Innovation Corp., Tokyo (JP)

(21) Appl. No.: 17/497,156

(22) Filed: Oct. 8, 2021

(30) Foreign Application Priority Data
May 25, 2021 (JP) 2021-087895

(51) Int. Cl. G03G 9/113; G03G 9/107; G03G 9/08; G03G 15/08

(52) U.S. Cl. CPC G03G 9/1139; G03G 9/108; G03G 9/1133; G03G 9/0819; G03G 9/0821; G03G 15/08

(57) ABSTRACT

A carrier for developing an electrostatic image includes a magnetic particle and a resin layer with which the magnetic particle is coated and which contains silica particles having an average particle diameter of 50 nm or more and 200 nm or less. In the carrier, a silicon element ratio Si1 in a region in which a distance from a surface of the resin layer in a direction toward an inside is 0.1 μm or more and 0.2 μm or less and a silicon element ratio Si2 in a region in which a distance from a surface of the magnetic particle in a direction toward the surface of the resin layer is 0.0 μm or more and 0.1 μm or less satisfy formula 1-1 and formula 2-1 below.

0.005≤Si1≤2 Formula 1-1

1≤Si1/Si2≤1000 Formula 2-1

### CROSS-REFERENCE TO RELATED APPLICATIONS

This application is based on and claims priority under 35 USC 119 from Japanese Patent Application No. 2021-087895 filed May 25, 2021.

### BACKGROUND

### (i) Technical Field

The present disclosure relates to a carrier for developing an electrostatic image, an electrostatic image developer, and an image forming method.

### (ii) Related Art

Japanese Unexamined Patent Application Publication No. 2011-186005 proposes “a carrier for developing electrostatic images that includes a carrier main body having a core and a coating resin layer coating the core and that includes spherical silica particles which have a volume-average particle diameter of 50 nm or more and 300 nm or less and adhere to a surface of the carrier main body at a proportion of 0.001 parts by mass or more and 0.100 parts by mass or less relative to 100 parts by mass of the carrier main body”.

Japanese Unexamined Patent Application Publication No. 09-319155 proposes “a carrier for developing electrostatic latent images that is obtained by coating a core with a resin, the carrier having a resin layer formed of at least three resins of a triazine ring-containing curable resin, a crosslinking agent for crosslinking the curable resin, and a fluororesin which is not crosslinked”.

### SUMMARY

Aspects of non-limiting embodiments of the present disclosure relate to a carrier for developing an electrostatic image that includes a magnetic particle and a resin layer with which the magnetic particle is coated and which contains silica particles having an average particle diameter of 50 nm or more and 200 nm or less, the carrier suppressing the occurrence of image omission when an image with a low area coverage is continuously formed in a high-temperature and high-humidity environment, and then an image with a high area coverage is formed in a high-temperature and high-humidity environment compared with the case where the silicon element ratio Si1 in a region in which the distance from a surface of the resin layer in a direction toward the inside is 0.1 μm or more and 0.2 μm or less and the silicon element ratio Si2 in a region in which the distance from a surface of the magnetic particle in a direction toward the surface of the resin layer is 0.0 μm or more and 0.1 μm or less satisfy formula C1-1 or formula C2-1 below.

0.005>Si1 or Si1>2 Formula C1-1

1>Si1/Si2 or Si1/Si2>1000 Formula C2-1

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a carrier for developing an electrostatic image, the carrier including a magnetic particle and a resin layer with which the magnetic particle is coated and which contains silica particles having an average particle diameter of 50 nm or more and 200 nm or less, wherein a silicon element ratio Si1 in a region in which a distance from a surface of the resin layer in a direction toward an inside is 0.1 μm or more and 0.2 μm or less and a silicon element ratio Si2 in a region in which a distance from a surface of the magnetic particle in a direction toward the surface of the resin layer is 0.0 μm or more and 0.1 μm or less satisfy formula 1-1 and formula 2-1 below.

0.005≤Si1≤2 Formula 1-1

1≤Si1/Si2≤1000 Formula 2-1

### BRIEF DESCRIPTION OF THE DRAWINGS

Exemplary embodiments of the present disclosure will be described in detail based on the following figures, wherein:

FIG. 1 schematically illustrates one example of an image forming apparatus used in the exemplary embodiment; and

FIG. 2 schematically illustrates one example of a process cartridge used in the exemplary embodiment.

### DETAILED DESCRIPTION

Hereafter, exemplary embodiments of the present disclosure will be described. These descriptions and examples are intended to illustrate exemplary embodiments and not to limit the scope of the disclosure.

When numerical ranges are described stepwise in this specification, the upper limit or the lower limit of one numerical range may be replaced with an upper limit or a lower limit of another numerical range also described stepwise. In a numerical range described in this specification, the upper limit or the lower limit of the numerical range may be replaced with values described in examples.

Each component may contain a plurality of corresponding substances.

In the case where the amount of each component in a composition is stated, when a plurality of substances corresponding to each component are present in the composition, the amount of each component in the composition refers to a total amount of the plurality of substances that are present in the composition unless otherwise specified.

### Carrier for Developing Electrostatic Image

A carrier for developing an electrostatic image according to the exemplary embodiment (hereafter also referred to as a “carrier”) includes a magnetic particle and a resin layer with which the magnetic particle is coated and which contains silica particles having an average particle diameter of 50 nm or more and 200 nm or less.

The silicon element ratio Si1 in a region in which the distance from a surface of the resin layer in a direction toward the inside is 0.1 μm or more and 0.2 μm or less and the silicon element ratio Si2 in a region in which the distance from a surface of the magnetic particle in a direction toward the surface of the resin layer is 0.0 μm or more and 0.1 μm or less satisfy formula 1-1 and formula 2-1 below.

0.005≤Si1≤2 Formula 1-1

1≤Si1/Si2≤1000 Formula 2-1

In the above-described configuration, the carrier according to the exemplary embodiment suppresses the occurrence of image omission when an image with a low area coverage (e.g., an image with an area coverage of 1% or less) is continuously formed in a high-temperature and high-humidity environment (e.g., 28.5° C. and 85% RH), and then an image with a high area coverage (e.g., an image with an area coverage of 30% or more) is formed in a high-temperature and high-humidity environment (e.g., 28.5° C. and 85% RH). The reason for this is assumed as follows.

When an image with a low area coverage is continuously formed in a high-temperature and high-humidity environment, the resin layer of the carrier may be worn. In this case, a developing brush to which a developer including a carrier and a toner adheres and which is formed on a development sleeve is likely to have an irregular structure. In the case where the developing brush has an irregular structure, when an image with a high area coverage is formed in a high-temperature and high-humidity environment, charges are likely to be injected into the carrier during toner development, which may cause image omission. In the case where a color image is formed on white paper, if image omission occurs, the image omission is referred to as a white spot.

In the carrier according to the exemplary embodiment, the ratio Si1 satisfies the above formula 1-1. When the ratio Si1 is 0.005 or more, the amount of silica particles near the surface of the carrier increases, which may improve the wear resistance of the carrier. When the ratio Si1 is 2 or less, the amount of silica particles near the surface of the carrier is not excessively large. This may suppress a decrease in resistance of the carrier due to the inclusion of the silica particles. Thus, the injection of charges into the carrier during toner development may be easily suppressed.

When the ratio Si1 and the ratio Si2 satisfy the above formula 2-1, many silica particles are present near the surface of the carrier. This may facilitate a further improvement in wear resistance of the carrier.

Therefore, even when an image with a low area coverage is continuously formed in a high-temperature and high-humidity environment, the carrier according to the exemplary embodiment is prevented from being worn, and the developing brush is less likely to have an irregular structure. As a result, injection of charges into the carrier during toner development is suppressed.

From the above, it is assumed that the carrier according to the exemplary embodiment having the above-described configuration suppresses the occurrence of image omission when an image with a low area coverage is continuously formed in a high-temperature and high-humidity environment, and then an image with a high area coverage is formed in a high-temperature and high-humidity environment.

### Magnetic Particle

The magnetic particle is not particularly limited, and a publicly known magnetic particle used as a core for the carrier is applied. Specific examples of the magnetic particle include particles of magnetic metals such as iron, nickel, and cobalt; particles of magnetic oxides such as ferrite and magnetite; resin-impregnated magnetic particles obtained by impregnating a porous magnetic powder with a resin; and magnetic powder-dispersed resin particles obtained by dispersing a magnetic powder in a resin. In the exemplary embodiment, the magnetic particles are preferably ferrite particles.

The volume-average particle diameter of the magnetic particles is preferably 15 μm or more and 100 μm or less, more preferably 20 μm or more and 80 μm or less, and further preferably 30 μm or more and 60 μm or less.

Herein, the volume-average particle diameter refers to a particle diameter D50v at which the cumulative sum from the small diameter side reaches 50% in a volume-based particle size distribution.

The arithmetic surface roughness Ra (JIS B0601:2001) of the surfaces of the magnetic particles is preferably 0.2 μm or more and 2 μm or less and more preferably 0.4 μm or more and 1.3 μm or less.

When the arithmetic surface roughness Ra of the surfaces of the magnetic particles is within the above numerical range, the wear resistance of the carrier may be easily further improved. This may further suppress the occurrence of image omission when an image with a low area coverage is continuously formed in a high-temperature and high-humidity environment, and then an image with a high area coverage is formed in a high-temperature and high-humidity environment.

The arithmetic surface roughness Ra of the surfaces of the magnetic particles is determined by observing the magnetic particles at an appropriate magnification (e.g., a magnification of 1000 times) using a surface profile measuring instrument (e.g., “Color 3D Laser Microscope “VK-9700” manufactured by Keyence Corporation), obtaining a roughness curve at a cut-off value of 0.08 mm, and extracting a reference length of 10 μm from the roughness curve in a direction of the average line. The arithmetic surface roughness Ra is an arithmetic mean of 100 magnetic particles.

For the magnetic force of the magnetic particles, the saturation magnetization in a magnetic field of 3000 oersted is preferably 50 emu/g or more and more preferably 60 emu/g or more. The saturation magnetization is measured using a vibrating sample magnetometer VSM-P10-15 (manufactured by Toei Industry Co., Ltd.). The measurement sample is packed in a cell having an inner diameter of 7 mm and a height of 5 mm and set in the magnetometer. The measurement is performed by applying an applied magnetic field and performing sweeping to 3000 oersted at the maximum. Then, the applied magnetic field is decreased and a hysteresis curve is formed on a recording paper. The saturation magnetization, the residual magnetization, and the coercive force are determined from the data of the curve.

The volume electrical resistance (volume resistivity) of the magnetic particles is preferably 1×10³ Ω·cm or more and 1×10⁹ Ω·cm or less and more preferably 1×10⁷ Ω·cm or more and 1×10⁹ Ω·cm or less.

The volume electrical resistance (Ω·cm) of the magnetic particles is measured as follows. A measurement sample is placed flat on the surface of a circular jig provided with a 20 cm² electrode plate to form a layer having a thickness of 1 mm or more and 3 mm or less. Another 20 cm² electrode plate is placed on the layer to sandwich the layer between the electrode plates. After a load of 4 kg is applied to the electrode plate placed on the layer to remove gaps between the particles of the measurement sample, the thickness (cm) of the layer is measured. The electrodes above and below the layer are connected to an electrometer and a high-voltage power generator. A high voltage is applied across the electrodes to generate an electric field of 103.8 V/cm, and the current (A) flowing at this time is read out. The measurement environment is a temperature of 20° C. and a relative humidity of 50%. The calculation formula for the volume electrical resistance (Ω·cm) of the measurement sample is as described below.

R=E×20/(I−I₀)/L

In the formula, R represents the volume electrical resistance (Ω·cm) of the measurement sample, E represents the applied voltage (V), I represents the current (A), I₀ represents the current (A) at an applied voltage of 0 V, and L represents the thickness (cm) of the layer. A coefficient of 20 represents the area (cm²) of each electrode plate.

### Resin Layer

### Resin for Resin Layer

The resin layer contains a resin for the resin layer.

Examples of the resin for the resin layer include styrene-acrylate copolymers; polyolefin resins, such as polyethylene and polypropylene; polyvinyl or polyvinylidene resins, such as polystyrene, acrylic resin, polyacrylonitrile, polyvinyl acetate, polyvinyl alcohol, polyvinyl butyral, polyvinyl chloride, polyvinyl carbazole, polyvinyl ether, and polyvinyl ketone; vinyl chloride-vinyl acetate copolymers; straight-chain silicone resins having organosiloxane bonds, and modified products thereof; fluororesins, such as polytetrafluoroethylene, polyvinyl fluoride, polyvinylidene fluoride, and polychlorotrifluoroethylene; polyester; polyurethane; polycarbonate; amino resins, such as urea-formaldehyde resin; and epoxy resins.

The resin layer may include an acrylic resin having an alicyclic structure. The polymerization component of the acrylic resin having an alicyclic structure may be a lower alkyl ester of (meth)acrylic acid (e.g., an alkyl ester of (meth)acrylic acid in which the alkyl group has 1 to 9 carbon atoms), and is specifically methyl (meth)acrylate, ethyl (meth)acrylate, propyl (meth)acrylate, butyl (meth)acrylate, hexyl (meth)acrylate, cyclohexyl (meth)acrylate, and 2-ethylhexyl (meth)acrylate. These monomers may be used alone or in combination of two or more.

The acrylic resin having an alicyclic structure may contain cyclohexyl (meth)acrylate as a polymerization component. The content of a monomer unit derived from cyclohexyl (meth)acrylate contained in the acrylic resin having an alicyclic structure is preferably 75% by mass or more and 100% by mass or less, more preferably 85% by mass or more and 100% by mass or less, and further preferably 95% by mass or more and 100% by mass or less relative to the total mass of the acrylic resin having an alicyclic structure.

The thickness of the resin layer is preferably 0.3 μm or more and 3.0 μm or less, more preferably 0.4 μm or more and 2.0 μm or less, and further preferably 0.5 μm or more and 1.5 μm or less.

When the thickness of the resin layer is within the above numerical range, the wear resistance of the carrier may be easily further improved. This may provide a carrier capable of further suppressing the occurrence of image omission when an image with a low area coverage is continuously formed in a high-temperature and high-humidity environment, and then an image with a high area coverage is formed in a high-temperature and high-humidity environment.

The thickness of the resin layer is determined by the following method.

The carrier is embedded in an epoxy resin and cut with a microtome to form a carrier section. The carrier section is photographed using a scanning electron microscope (SEM) and the resultant SEM image is imported into an image processing analyzer and subjected to image analysis. The thicknesses (μm) of the resin layer at randomly selected 10 points of a single particle of the carrier are measured. This measurement is further performed for 100 particles of the carrier, and all the measured thicknesses are arithmetically averaged to determine a thickness (μm) of the resin layer.

The content of the resin for the resin layer is preferably 50% by mass or more and 100% by mass or less, more preferably 52% by mass or more and 98% by mass or less, and further preferably 55% by mass or more and 95% by mass or less relative to the entire resin layer.

### Silica Particle

The resin layer contains silica particles.

Examples of the silica particles include dry silica particles and wet silica particles.

Examples of the dry silica particles include pyrogenic silica (fumed silica) obtained by burning a silane compound, and deflagration silica obtained by deflagration of a metal silicon powder.

Examples of the wet silica particles include wet silica particles obtained by neutralization reaction of sodium silicate and a mineral acid (precipitated silica synthesized and aggregated under alkaline conditions and gel silica particles synthesized and aggregated under acidic conditions), colloidal silica particles obtained by alkalifying and polymerizing acidic silicate (silica sol particles), and sol-gel silica particles obtained by hydrolysis of an organic silane compound (e.g., alkoxysilane).

Among them, the silica particles are preferably the wet silica particles.

The average particle diameter of the silica particles is 50 nm or more and 200 nm or less.

From the viewpoint of providing a carrier capable of further suppressing the occurrence of image omission when an image with a low area coverage is continuously formed in a high-temperature and high-humidity environment, and then an image with a high area coverage is formed in a high-temperature and high-humidity environment, the average particle diameter of the silica particles is preferably 50 nm or more and 200 nm or less, more preferably 53 nm or more and 180 nm or less, and further preferably 55 nm or more and 150 nm or less.

The average particle diameter of the silica particles is measured as follows.

The carrier is embedded in an epoxy resin and cut with a microtome to form a carrier section. The carrier section is photographed using a scanning electron microscope (SEM) and the resultant SEM image is imported into an image processing analyzer and subjected to image analysis. One hundred silica particles (primary particles) in the resin layer are randomly selected, and the equivalent circle diameters (nm) of the silica particles are determined. The equivalent circle diameters are arithmetically averaged to determine an average particle diameter (nm) of the silica particles.

The surface of the silica particles may be subjected to hydrophobic treatment. The hydrophobizing agent is, for example, a publicly known organosilicon compound having an alkyl group (e.g., a methyl group, an ethyl group, a propyl group, and a butyl group). Specific examples of the hydrophobizing agent include alkoxysilane compounds, siloxane compounds, and silazane compounds. Among them, the hydrophobizing agent is preferably a silazane compound and more preferably hexamethyldisilazane. The hydrophobizing agents may be used alone or in combination of two or more.

Examples of the method of subjecting the silica particles to hydrophobic treatment using a hydrophobizing agent include a method of dissolving a hydrophobizing agent in supercritical carbon dioxide to cause the hydrophobizing agent to adhere to the surfaces of the silica particles; a method of performing, in the air, application (e.g., spraying or coating) of a solution including a hydrophobizing agent and a solvent for dissolving the hydrophobizing agent onto the surfaces of the silica particles, to cause the hydrophobizing agent to adhere to the surfaces of the silica particles; and a method of, in the air, adding a solution including a hydrophobizing agent and a solvent for dissolving the hydrophobizing agent to a silica particle dispersion liquid, and holding and subsequently drying the mixed solution of the silica particle dispersion liquid and the solution.

### Conductive Material

The resin layer may include a conductive material.

Examples of the conductive material include carbon black, metals such as gold, silver, and copper, titanium oxide, zinc oxide, tin oxide, barium sulfate, aluminum borate, potassium titanate, tin oxide, antimony-doped tin oxide, tin-doped indium oxide, aluminum-doped zinc oxide, and resin particles coated with a metal.

The content of the conductive material is preferably 0% by mass or more and 10% by mass or less and more preferably 0.05% by mass or more and 5% by mass or less relative to the entire resin layer.

### Resin Particle

The resin layer may include resin particles.

Examples of the resin particles include thermosetting resin particles and crosslinked resin particles.

The thermosetting resin particles are not particularly limited as long as they are particles formed of a thermosetting resin, but are preferably particles formed of a resin containing a nitrogen element. In particular, melamine resin, urea resin, urethane resin, guanamine resin, and amide resin may be used because they are highly positively chargeable and also have high resin hardness, and thus a decrease in charge amount due to, for example, peeling of a resin layer is suppressed.

Commercially available thermosetting resin particles can also be used. Examples of the thermosetting resin particles include Epostar S (manufactured by Nippon Shokubai Co., Ltd., melamine-formaldehyde condensed resin) and Epostar MS (manufactured by Nippon Shokubai Co., Ltd., benzoguanamine-formaldehyde condensed resin).

The content of the conductive material is preferably 0% by mass or more and 10% by mass or less and more preferably 0.05% by mass or more and 5% by mass or less relative to the entire resin layer.

### Characteristics of Carrier

### Silicon Element Ratio

The silicon element ratio Si1 in a region in which the distance from a surface of the resin layer in a direction toward the inside is 0.1 μm or more and 0.2 μm or less and the silicon element ratio Si2 in a region in which the distance from a surface of the magnetic particle in a direction toward the surface of the resin layer is 0.0 μm or more and 0.1 μm or less satisfy the following formula 1-1 and formula 2-1.

0.005≤Si1≤2 Formula 1-1

1≤Si1/Si2≤1000 Formula 2-1

Herein, when the formula 2-1 is satisfied, many silica particles are included in a region close to the surface of the resin layer of the carrier. This may improve the wear resistance of the carrier. Furthermore, when the formula 2-1 is satisfied, the number of silica particles is small in the vicinity of the surface of the magnetic particle of the carrier. This may improve the adhesion of the resin layer to the magnetic particle, which may facilitate a further improvement of the wear resistance of the carrier.

From the viewpoint of providing a carrier capable of further suppressing the occurrence of image omission when an image with a low area coverage is continuously formed in a high-temperature and high-humidity environment, and then an image with a high area coverage is formed in a high-temperature and high-humidity environment, the ratio Si1 and the ratio Si2 preferably satisfy the following formula 1-2 and formula 2-2.

0.01≤Si1≤1 Formula 1-2

50≤Si1/Si2≤4000 Formula 2-2

The ratio Si1 and the ratio Si2 are measured as follows.

Etching is performed in a direction from the surface of the carrier toward the inside, and the silicon element ratio on the surface after the etching is measured every 150 nm by X-ray photoelectron spectrometry (XPS). The etching and XPS measurement are performed until the etching reaches the surface of the magnetic particle. The ratio Si1 is an arithmetic mean of the silicon element ratios measured in a region in which the distance from the surface of the resin layer in a direction toward the inside is 0.1 μm or more and 0.2 μm or less. The ratio Si2 is an arithmetic mean of the silicon element ratios measured in a region in which the distance from the surface of the magnetic particle in a direction toward the surface of the resin layer is 0.0 μm or more and 0.1 μm or less.

The silicon element ratio is measured by XPS as follows.

The measurement is performed with an X-ray photoelectron spectrometer (XPS) (JPS-9000MX manufactured by JEOL Ltd.) using MgKα rays as an X-ray source at an acceleration voltage of 20 kV and an emission current of 10 mA. The number of each atom is determined from the measured spectra of carbon, oxygen, and silicon. The ratio of the atomic weight of silicon to the total of the atomic weight of carbon, the atomic weight of oxygen, and the atomic weight of silicon in the measurement region is calculated and defined as a silicon element ratio.

Furthermore, an etching method will be described.

Specifically, a region of the resin layer with six-millimeter sides is etched using an argon gas cluster ion gun.

### Etching Conditions

Etching gun: Argon gas cluster ion gun

Degree of vacuum: (3±1)×10⁻² Pa

Measurement intensity: 400 eV, 6 mA

Sweep region: 6 mm×6 mm

### Volume-Average Particle Diameter

The volume-average particle diameter of the carrier is 20 μm or more and 50 μm or less.

From the viewpoint of further suppressing the occurrence of uneven image density when an image with a low area coverage is continuously formed in a high-temperature and high-humidity environment, and then an image with a high area coverage is formed in a high-temperature and high-humidity environment, the volume-average particle diameter of the carrier is preferably 23 μm or more and 47 μm or less, more preferably 25 μm or more and 45 μm or less, and further preferably 27 μm or more and 43 μm or less.

The volume-average particle diameter of the carrier is measured as follows.

The measurement is performed with a Coulter Multisizer II (manufactured by Beckman Coulter Inc.) using ISOTON-II (manufactured by Beckman Coulter Inc.) as an electrolyte solution. First, 0.5 mg or more and 50 mg or less of a measurement sample is added to 2 ml of a 5 mass % aqueous solution of a surfactant (e.g., sodium alkylbenzenesulfonate) serving as a dispersing agent. The resulting mixture is added to 100 ml or more and 150 ml or less of the electrolyte solution. The electrolyte solution in which the measurement sample has been suspended is dispersed for about 1 minute with an ultrasonic disperser, and the particle size distribution of the particles having a particle diameter in the range of 2.0 μm or more and 60 μm or less is measured by using the Coulter Multisizer II with an aperture having a diameter of 100 μm. Here, the number of particles for measurement is set to 50,000.

For the measured particle size distribution, a cumulative distribution of volume is plotted from the small diameter size with respect to the split particle size ranges (channels), and the particle diameter at 50% accumulation is defined as a volume-average particle diameter (D₅₀ᵥ).

### Method for Producing Carrier

The method for producing a carrier used in the exemplary embodiment is not particularly limited as long as the carrier used in the exemplary embodiment can be formed. Hereafter, an example of the method for producing a carrier according to the exemplary embodiment will be described.

The carrier according to the exemplary embodiment is produced by, for example, an immersion method in which magnetic particles are immersed in a resin layer-forming solution, a spray method in which a resin layer-forming solution stirred and dispersed using a stirrer (e.g., a sand mill) is sprayed onto the surfaces of the magnetic particles, a fluidized-bed method in which a resin layer-forming solution is sprayed while magnetic particles are suspended by using flowing air, or a kneader-coater method in which a resin layer-forming solution and magnetic particles are mixed in a kneader-coater and then the solvent is removed.

Alternatively, a method for producing a carrier by causing a particle resin to adhere to a core material without using a solvent and by performing heating for melting may be employed. A dry coating method is, for example, a powder coating method in which coating resin particles and core particles are heated or mixed at a high speed to coat the core particles with the coating resin particles.

The method for producing a carrier according to the exemplary embodiment may be a kneader-coater method from the viewpoint of setting the ratio Si1 and the ratio Si2 within particular ranges.

The method for producing a carrier according to the exemplary embodiment may include a first step of mixing a resin layer-forming solution A and magnetic particles in a kneader-coater and then removing a solvent to obtain a first coated carrier and a second step of mixing a resin layer-forming solution B and the first coated carrier in a kneader-coater and then removing a solvent to obtain a carrier.

### First Step

The resin layer-forming solution A may contain, for example, a resin for the resin layer, a solvent, and silica particles.

The content of the resin for the resin layer in the resin layer-forming solution A may be 10% by mass or more and 30% by mass or less relative to the entire solution.

The content of the silica particles in the resin layer-forming solution A may be 0.001% by mass or more and 0.01% by mass or less relative to the entire solution.

For the amount of the resin layer-forming solution A added in the first step, the solid content of the resin layer-forming solution A may be 0.5 parts by mass or more and 1.5 parts by mass or less relative to 100 parts by mass of the magnetic particles.

### Second Step

The resin layer-forming solution B may contain, for example, a resin for the resin layer, a solvent, and silica particles.

The content of the resin for the resin layer in the resin layer-forming solution B may be 10% by mass or more and 30% by mass or less relative to the entire solution.

The content of the silica particles in the resin layer-forming solution B may be 0.1% by mass or more and 1.0% by mass or less relative to the entire solution.

The content of the silica particles in the resin layer-forming solution B may be higher than the content of the silica particles in the resin layer-forming solution A. This may provide a carrier in which the silicon element ratio Si1 and the silicon element ratio Si2 readily satisfy the formula 1-1 and the formula 2-1.

For the amount of the resin layer-forming solution B added in the second step, the solid content of the resin layer-forming solution B may be 1.5 parts by mass or more and 2.5 parts by mass or less relative to 100 parts by mass of the first coated carrier.

The solvent used for the resin layer-forming solution is not particularly limited as long as the resin is dissolved in the solvent. Examples of the solvent include aromatic hydrocarbons such as xylene and toluene, ketones such as acetone and methyl ethyl ketone, ethers such as tetrahydrofuran and dioxane, and halides such as chloroform and carbon tetrachloride.

After each of the first step and the second step, a sieving step of removing coarse particles may be included.

In the exemplary embodiment, a method for producing magnetic particles is not particularly limited, and an example of the production method will be described.

The magnetic particles are produced in accordance with, for example, the following typical method for producing ferrite core particles. Appropriate amounts of oxides are mixed, and water is added thereto. The resulting mixture is pulverized and mixed with a wet ball mill, a wet vibrating mill, or the like for, for example, 1 hour or more, preferably 1 hour or more and 20 hours or less. The thus-obtained slurry is dried, further pulverized, and then calcined at a temperature of, for example, 700° C. or higher and 1200° C. or lower. After the calcination, the resulting product is further pulverized with a wet ball mill, a wet vibrating mill, or the like to obtain a mixed powder having a particle diameter of 1 μm or less. The obtained mixed powder is granulated using a granulation device such as a spray dryer, and the granulated powder is held at a temperature of, for example, 1000° C. or higher and 1500° C. or lower for 1 hour or longer and 24 hours or shorter to perform main firing.

In the exemplary embodiment, the arithmetic surface roughness Ra of the surfaces of the obtained magnetic particles is controlled by adjusting the particle diameter of the mixed powder obtained by pulverization with a mill or the like after the calcination, the granulation method, and the firing temperature.

The raw material for the magnetic particles may be a publicly known material, but is preferably ferrite or magnetite. For example, iron powder is known as another raw material. In the case of iron powder, the iron powder has a large specific gravity and thus tends to deteriorate the toner. Therefore, ferrite or magnetite is better in terms of stability. Examples of ferrite, which is a raw material composition of magnetic particles, include ferrite generally represented by the following formula.

(MO)_{X}(Fe₂O₃)_{Y}

In the formula, M includes at least one selected from Cu, Zn, Fe, Mg, Mn, Li, Ti, Ni, Sn, Sr, Si, Al, Ba, Co, Mo, Ca, and the like. X and Y represent a mass molar ratio and satisfy the condition X+Y=100.

### Electrostatic Image Developer

The electrostatic image developer according to the exemplary embodiment is a two-component developer containing the carrier according to the exemplary embodiment and a toner for developing an electrostatic image (hereafter also simply referred to as “toner”).

The mixing ratio (mass ratio) of the toner and the carrier in the two-component developer is preferably toner:carrier=1:100 to 30:100 and more preferably 3:100 to 20:100.

Hereafter, the toner used in the electrostatic image developer according to the exemplary embodiment will be described.

### Toner for Developing Electrostatic Image

The toner for developing an electrostatic image according to the exemplary embodiment (hereafter also simply referred to as a toner) includes toner particles and optionally an external additive.

The toner particles include, for example, a binder resin and optionally a colorant, a release agent, and other additives.

The binder resin, colorant, release agent, and other additives contained in the toner particles and the external additive are not particularly limited, and publicly known products used for toners are employed.

### Characteristics of Toner Particles

The toner particles may be toner particles having a single-layer structure or may be toner particles having a so-called core-shell structure constituted by a core (core particle) and a coating layer (shell layer) that coats the core.

Herein, the toner particles having a core-shell structure may be constituted by, for example, a core containing a binder resin and optionally other additives such as a colorant and a release agent, and a coating layer containing a binder resin.

The volume-average particle diameter (D50v) of the toner particles is preferably 2 μm or more and 10 μm or less and more preferably 4 μm or more and 8 μm or less.

Various average particle diameters and various particle diameter distribution indexes of the toner particles are measured with a Coulter Multisizer II (manufactured by Beckman Coulter, Inc.) using ISOTON-II (manufactured by Beckman Coulter, Inc.) as an electrolyte solution.

During the measurement, 0.5 mg or more and 50 mg or less of a measurement sample is added to 2 ml of a 5% aqueous solution of a surfactant (e.g., sodium alkylbenzenesulfonate) serving as a dispersing agent. This is added to 100 ml or more and 150 ml or less of the electrolyte solution.

The electrolyte solution in which the sample has been suspended is dispersed for 1 minute with an ultrasonic disperser, and the particle size distribution of the particles having a particle diameter in the range of 2 μm or more and 60 μm or less is measured by using the Coulter Multisizer II with an aperture having a diameter of 100 μm. The number of particles to be sampled is 50000.

Cumulative distributions of the volume and number are each plotted from the small diameter size with respect to the particle size ranges (channels) split on the basis of the particle size distribution to be measured. The particle diameter at 16% accumulation is defined as a volume particle diameter D16v and a number particle diameter D16p, the particle diameter at 50% accumulation is defined as a volume-average particle diameter D50v and a number-average particle diameter D50p, and the particle diameter at 84% accumulation is defined as a volume particle diameter D84v and a number particle diameter D84p.

From these values, the volume particle size distribution index (GSDv) is calculated as (D84v/D16v)^{1/2} and the number particle size distribution index (GSDp) is calculated as (D84p/D16p)^{1/2}.

The average circularity of the toner particles is preferably 0.94 or more and 1.00 or less and more preferably 0.95 or more and 0.98 or less.

The average circularity of the toner particles is determined from (circle-equivalent perimeter)/(perimeter) [(perimeter of circle with projected area equal to that of particle image)/(perimeter of projected particle image)). Specifically, the average circularity is measured by the following method.

The toner particles to be measured are first sampled by suction to form a flat flow. Particle images are captured as still images by causing a strobe light to flash. The particle images are analyzed with a flow particle image analyzer (FPIA-3000 manufactured by Sysmex Corporation). The number of particles sampled to determine the average circularity is 3500.

If the toner contains an external additive, the toner (developer) to be measured is dispersed in water containing a surfactant and then sonicated to obtain toner particles from which the external additive has been removed.

### Method for Producing Toner

Next, a method for producing a toner according to the exemplary embodiment will be described.

The toner according to the exemplary embodiment is obtained by producing toner particles and then externally adding an external additive to the toner particles.

The toner particles may be produced by either a dry process (e.g., kneading-pulverizing process) or a wet process (e.g., aggregation-coalescence process, suspension polymerization process, and dissolution suspension process). The process for producing toner particles is not particularly limited to the above processes, and a well-known process may be employed.

In particular, the toner particles may be produced by an aggregation-coalescence process.

Specifically, for example, the toner particles are produced by an aggregation-coalescence process as follows.

The toner particles are produced through a step (resin particle dispersion liquid providing step) of providing a resin particle dispersion liquid in which resin particles serving as a binder resin are dispersed, a step (aggregated-particle forming step) of aggregating the resin particles (and optionally other particles) in the resin particle dispersion liquid (if necessary, in a dispersion liquid prepared by mixing other particle dispersion liquids) to form aggregated particles, and a step (coalescing step) of heating an aggregated particle dispersion liquid in which the aggregated particles are dispersed to cause the aggregated particles to coalesce, thereby forming toner particles.

The toner according to the exemplary embodiment is produced by, for example, mixing the resulting dry toner particles with an external additive. The mixing may be performed using, for example, a V-blender, a Henschel mixer, or a Lödige mixer. Optionally, coarse toner particles may be removed using, for example, a vibrating screen or an air screen.

### Image Forming Apparatus and Image Forming Method

An image forming apparatus and an image forming method according to the exemplary embodiment will be described.

The image forming apparatus according to the exemplary embodiment includes an image holding member; a charging unit that charges a surface of the image holding member; an electrostatic image forming unit that forms an electrostatic image on the charged surface of the image holding member; a developing unit that accommodates an electrostatic image developer and develops, as a toner image, the electrostatic image formed on the surface of the image holding member with the electrostatic image developer; a transfer unit that transfers the toner image formed on the surface of the image holding member onto a surface of a recording medium; and a fixing unit that fixes the toner image transferred onto the surface of the recording medium. The electrostatic image developer according to the exemplary embodiment is applied as the electrostatic image developer.

In the image forming apparatus according to the exemplary embodiment, an image forming method (image forming method according to the exemplary embodiment) is performed which includes a charging step of charging a surface of an image holding member; an electrostatic image forming step of forming an electrostatic image on the charged surface of the image holding member; a developing step of developing, as a toner image, the electrostatic image formed on the surface of the image holding member using the electrostatic image developer according to the exemplary embodiment; a transfer step of transferring the toner image formed on the surface of the image holding member onto a surface of a recording medium; and a fixing step of fixing the toner image transferred onto the surface of the recording medium.

The image forming apparatus according to the exemplary embodiment is applicable to well-known image forming apparatuses such as a direct-transfer image forming apparatus in which a toner image formed on a surface of an image holding member is directly transferred onto a recording medium, an intermediate-transfer image forming apparatus in which a toner image formed on a surface of an image holding member is subjected to first transfer onto a surface of an intermediate transfer body and the toner image transferred onto the surface of the intermediate transfer body is subjected to second transfer onto a surface of a recording medium, an image forming apparatus including a cleaning unit that cleans a surface of an image holding member before charging and after transfer of a toner image, and an image forming apparatus including a charge eraser that erases electricity by irradiating a surface of an image holding member with erasing light before charging and after transfer of a toner image.

In the case of the intermediate-transfer image forming apparatus, the transfer unit includes an intermediate transfer body having a surface onto which a toner image is to be transferred, a first transfer unit that transfers a toner image formed on a surface of an image holding member onto a surface of the intermediate transfer body, and a second transfer unit that transfers the toner image transferred onto the surface of the intermediate transfer body onto a surface of a recording medium.

In the image forming apparatus according to the exemplary embodiment, for example, the developing unit may be a part of a cartridge structure (process cartridge) detachably attachable to the image forming apparatus. The process cartridge is, for example, a process cartridge including a developing unit that accommodates the electrostatic image developer according to the exemplary embodiment.

Hereafter, an example of the image forming apparatus according to the exemplary embodiment will be described, but the image forming apparatus is not limited thereto. Only principal parts illustrated in the drawings are described, and the description of other parts is omitted.

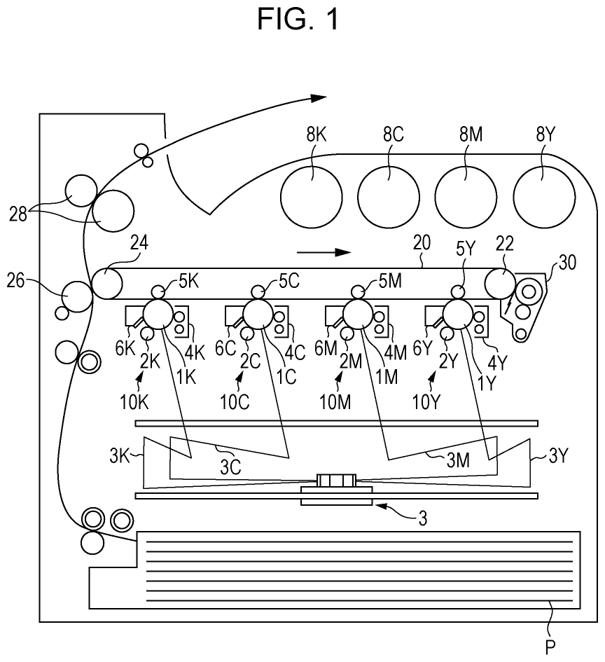

FIG. 1 schematically illustrates the image forming apparatus according to the exemplary embodiment.

The image forming apparatus illustrated in FIG. 1 includes first to fourth electrophotographic image forming units 10Y, 10M, 10C, and 10K that form yellow (Y), magenta (M), cyan (C), and black (K) images, respectively, based on color separation image data. These image forming units (hereafter simply referred to as “units”) 10Y, 10M, 10C, and 10K are arranged away from each other at predetermined intervals in the horizontal direction. These units 10Y, 10M, 10C, and 10K may be process cartridges detachably attachable to the image forming apparatus.

An intermediate transfer belt 20 serving as an intermediate transfer body is disposed above the units 10Y, 10M, 10C, and 10K in the drawing so as to pass through each unit. The intermediate transfer belt 20 is wound around a drive roller 22 and a support roller 24 that are separated from each other in the left-to-right direction in the drawing. The support roller 24 is disposed in contact with the inner surface of the intermediate transfer belt 20. The intermediate transfer belt 20 runs in a direction from the first unit 10Y toward the fourth unit 10K. A force that urges the support roller 24 to move in a direction away from the drive roller 22 is applied to the support roller 24 by using a spring or the like not illustrated in the drawing so that a tension is applied to the intermediate transfer belt 20 wound around the support roller 24 and the drive roller 22. An intermediate transfer body cleaning device 30 that faces the drive roller 22 is disposed on the surface of the intermediate transfer belt 20 that carries images.

Toners of four colors, yellow, magenta, cyan, and black, are stored in toner cartridges 8Y, 8M, 8C, and 8K and supplied to developing devices (developing units) 4Y, 4M, 4C, and 4K of the units 10Y, 10M, 10C, and 10K.

Since the first to fourth units 10Y, 10M, 10C, and 10K have the same configuration, the following description will focus on the first unit 10Y, which is a yellow image-forming unit disposed upstream in the intermediate transfer belt running direction. Note that parts equivalent to those of the first unit 10Y are referred by reference signs having magenta (M), cyan (C), or black (K) added thereto instead of yellow (Y) to omit the descriptions of the second to fourth units 10M, 10C, and 10K.

The first unit 10Y has a photoreceptor 1Y that serves as an image holding member. A charging roller (one example of the charging unit) 2Y that charges the surface of the photoreceptor 1Y to a predetermined potential, an exposing device (one example of the electrostatic image forming unit) 3 that forms an electrostatic image by exposing the charged surface with a laser beam 3Y on the basis of a color-separated image signal, a developing device (one example of the developing unit) 4Y that develops the electrostatic image by supplying the charged toner to the electrostatic image, a first transfer roller 5Y (one example of the first transfer unit) that transfers the developed toner image onto the intermediate transfer belt 20, and a photoreceptor cleaning device (one example of the cleaning unit) 6Y that removes the toner remaining on the surface of the photoreceptor 1Y after the first transfer are arranged in this order around the photoreceptor 1Y.

The first transfer roller 5Y is disposed on the inner side of the intermediate transfer belt 20 and faces the photoreceptor 1Y. Furthermore, each of the first transfer rollers 5Y, 5M, 5C, and 5K is connected to a bias power supply (not illustrated) that applies a first transfer bias. The controller not illustrated in the drawing controls each of the bias power supplies so as to vary the transfer biases to be applied to the corresponding first transfer rollers.

Hereafter, the operation of forming a yellow image in the first unit 10Y will be described.

First, before the operation, the charging roller 2Y charges the surface of the photoreceptor 1Y to a potential of −600 V to −800 V.

The photoreceptor 1Y includes a conductive substrate (e.g., a substrate having a volume resistivity of 1×10⁻⁶ Ωcm or less at 20° C.) and a photosensitive layer stacked on the substrate. The photosensitive layer, which normally has high resistivity (a resistivity similar to those of typical resins), has a property of changing its resistivity in a region irradiated with a laser beam 3Y. The laser beam 3Y is emitted from the exposing device 3 toward the charged surface of the photoreceptor 1Y based on yellow image data sent from a controller (not illustrated). The laser beam 3Y impinges on the photosensitive layer of the photoreceptor 1Y to form an electrostatic image corresponding to a yellow image pattern on the surface of the photoreceptor 1Y.

Electrostatic images are images formed on the surface of the photoreceptor 1Y by performing charging. Electrostatic images are negative latent images formed when electric charge dissipates from the surface of the photoreceptor 1Y due to decreased resistivity of the photosensitive layer in a region irradiated with the laser beam 3Y while remaining in a region not irradiated with the laser beam 3Y.

The electrostatic image formed on the photoreceptor 1Y is transported to a predetermined development position as the photoreceptor 1Y is rotated. The electrostatic image on the photoreceptor 1Y is made visible (i.e., developed) as a toner image at the development position by the developing device 4Y.

The developing device 4Y accommodates an electrostatic image developer including at least a yellow toner and a carrier. The yellow toner is triboelectrically charged by being stirred inside the developing device 4Y. The yellow toner is charged to the same polarity (negative polarity) as the surface of the photoreceptor 1Y and is carried by a developer roller (one example of the developer carrier). When the surface of the photoreceptor 1Y passes through the developing device 4Y, the yellow toner is electrostatically attached to a latent image portion, from which electricity has been removed, on the surface of the photoreceptor 1Y to develop the latent image with the yellow toner. The photoreceptor 1Y on which the yellow toner image has been formed continues to rotate at a predetermined speed and conveys the toner image formed on the photoreceptor 1Y to a predetermined first transfer position.

When the yellow toner image on the photoreceptor 1Y is conveyed to the first transfer position, a first transfer bias is applied to the first transfer roller 5Y. An electrostatic force from the photoreceptor 1Y toward the first transfer roller 5Y is exerted on the toner image to transfer the toner image on the photoreceptor 1Y onto the intermediate transfer belt 20. The transfer bias applied herein has a polarity (+) opposite to the polarity (−) of the toner. For example, the transfer bias applied in the first unit 10Y is controlled to +10 μA by a controller (not illustrated).

The toner left on the photoreceptor 1Y is removed and collected by the photoreceptor cleaning device 6Y.

The first transfer biases applied to the first transfer rollers 5M, 5C, and 5K of the second to fourth units 10M, 10C, and 10K are also controlled in the same manner as the first unit.

Thus, the intermediate transfer belt 20 on which the yellow toner image has been transferred by the first unit 10Y is sequentially transported through the second to fourth units 10M, 10C, and 10K, and toner images of different colors are transferred to the intermediate transfer belt 20 such that they are superimposed on top of each other.

The intermediate transfer belt 20 onto which the toner images of four colors have been transferred using the first to fourth units then reaches a second transfer section. The second transfer section is constituted by the intermediate transfer belt 20, the support roller 24 in contact with the inner surface of the intermediate transfer belt 20, and a second transfer roller (one example of the second transfer unit) 26 disposed on the image-carrying surface side of the intermediate transfer belt 20. A recording sheet (one example of the recording medium) P is fed at a predetermined timing through a feeding mechanism to a space where the second transfer roller 26 and the intermediate transfer belt 20 contact each other. A second transfer bias is then applied to the support roller 24. The transfer bias applied at this time has a polarity (−) that is the same as the polarity (−) of the toner. The electrostatic force from the intermediate transfer belt 20 toward the recording sheet P is exerted on the toner image, and the toner image on the intermediate transfer belt 20 is transferred onto the recording sheet P. The second transfer bias is determined in accordance with the resistance of the second transfer section detected with a resistance detector (not illustrated) and is controlled by voltage.

Subsequently, the recording sheet P is sent to the contact portion (nip) between a pair of fixing rollers in the fixing device (one example of the fixing unit) 28, and the toner image is fixed onto the recording sheet P to form a fixed image.

An example of the recording sheet P onto which the toner image is transferred is plain paper used in electrophotographic copiers, printers, and the like. The recording medium may be an overhead projector (OHP) sheet instead of the above recording sheet P.

In order to further improve the smoothness of the surface of the image after fixing, the surface of the recording sheet P may also be smooth. For example, coated paper which is plain paper having a surface coated with a resin or the like and art paper for printing may be used.

The recording sheet P after fixing of the color image is conveyed toward a discharge unit, and this completes a series of color image forming operations.

### Process Cartridge and Toner Cartridge

A process cartridge according to the exemplary embodiment will be described.

The process cartridge according to the exemplary embodiment is a process cartridge that is detachably attachable to an image forming apparatus and includes a developing unit that accommodates the electrostatic image developer according to the exemplary embodiment and develops, as a toner image, an electrostatic image formed on a surface of an image holding member.

The process cartridge according to the exemplary embodiment is not limited to the above configuration, and may include a developing device and optionally at least one selected from other units such as an image holding member, a charging unit, an electrostatic image forming unit, and a transfer unit.

Hereafter, an example of the process cartridge according to the exemplary embodiment will be described, but the process cartridge is not limited thereto. Only principal parts illustrated in the drawing are described, and the description of other parts is omitted.

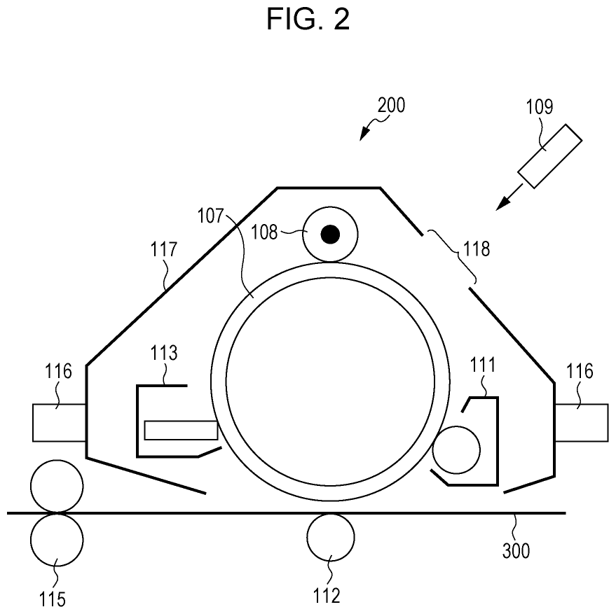

FIG. 2 schematically illustrates the process cartridge according to the exemplary embodiment.

A process cartridge 200 illustrated in FIG. 2 includes, for example, a photoreceptor 107 (one example of the image holding member), and a charging roller 108 (one example of the charging unit), a developing device 111 (one example of the developing unit), and a photoreceptor cleaning device 113 (one example of the cleaning unit) that are disposed around the photoreceptor 107. A housing 117 having mounting rails 116 and an opening 118 for exposure combines and integrates the aforementioned components to provide a cartridge.

In FIG. 2, 109 denotes an exposing device (one example of the electrostatic image forming unit), 112 denotes a transfer device (one example of the transfer unit), 115 denotes a fixing device (one example of the fixing unit), and 300 denotes a recording sheet (one example of the recording medium).

Next, a toner cartridge according to the exemplary embodiment will be described.

The toner cartridge according to the exemplary embodiment is detachably attachable to an image forming apparatus and accommodates the toner according to the exemplary embodiment. The toner cartridge is used for accommodating refill toners to be supplied to the developing unit disposed inside the image forming apparatus.

The image forming apparatus illustrated in FIG. 1 has detachable toner cartridges 8Y, 8M, 8C, and 8K, and the developing devices 4Y, 4M, 4C, and 4K are connected to the toner cartridges of corresponding colors through toner supply ducts not illustrated in the drawing. When the toner contained in a toner cartridge runs low, the toner cartridge is replaced.

### EXAMPLES

Examples of the present disclosure will be described below, but the present disclosure is not limited to Examples below. In the description below, “parts” and “%” are on a mass basis unless otherwise specified.

### Production of Toner

### Preparation of Amorphous Polyester Resin Dispersion Liquid (A1)

Ethylene glycol: 37 parts
Neopentyl glycol: 65 parts
1,9-Nonanediol: 32 parts
Terephthalic acid: 96 parts

The above materials are charged into a flask and heated to a temperature of 200° C. over 1 hour. After it is confirmed that uniform stirring is achieved in the reaction system, 1.2 parts of dibutyltin oxide is added thereto. The temperature is increased to 240° C. over 6 hours while water produced is distilled off, and stirring is continued at 240° C. for 4 hours to obtain an amorphous polyester resin (acid value: 9.4 mgKOH/g, weight-average molecular weight: 13,000, glass transition temperature: 62° C.). The amorphous polyester resin in a molten state is transferred to an emulsifying-dispersing apparatus (CAVITRON CD1010, EUROTEC Co., Ltd.) at a rate of 100 g per minute. Separately, 0.37% diluted ammonia water prepared by diluting reagent ammonia water with ion-exchanged water is placed in a tank. The diluted ammonia water is transferred to the emulsifying-dispersing apparatus together with the amorphous polyester resin at a rate of 0.1 L per minute while being heated to 120° C. using a heat exchanger. The emulsifying-dispersing apparatus is operated under the following conditions: rotor rotation speed 60 Hz and pressure 5 kg/cm² to obtain an amorphous polyester resin dispersion liquid (A1) having a volume-average particle diameter of 160 nm and a solid content of 20%.

### Preparation of Crystalline Polyester Resin Dispersion Liquid (C1)

Decanedioic acid: 81 parts
Hexanediol: 47 parts

The above materials are charged into a flask and heated to a temperature of 160° C. over 1 hour. After it is confirmed that uniform stirring is achieved in the reaction system, 0.03 parts of dibutyltin oxide is added thereto. The temperature is increased to 200° C. over 6 hours while water produced is distilled off, and stirring is continued at 200° C. for 4 hours. Next, the reaction solution is cooled and subjected to solid-liquid separation. The solid is dried at a temperature of 40° C. under reduced pressure to obtain a crystalline polyester resin (C1) (melting point: 64° C., weight-average molecular weight: 15,000).
Crystalline polyester resin (C1): 50 parts
Anionic surfactant (manufactured by DKS Co., Ltd., NEOGEN RK): 2 parts
Ion-exchanged water: 200 parts

The above materials are heated to 120° C. and sufficiently dispersed with a homogenizer (ULTRA-TURRAX T50, IKA Japan), and then dispersed with a pressure discharge homogenizer. When the volume-average particle diameter reaches 180 nm, the resulting product is collected to obtain a crystalline polyester resin dispersion liquid (C1) having a solid content of 20%.

### Preparation of Release Agent Particle Dispersion Liquid (W1)

Paraffin wax (HNP-9 manufactured by Nippon Seiro Co., Ltd.): 100 parts
Anionic surfactant (manufactured by DKS Co., Ltd., NEOGEN RK): 1 part
Ion-exchanged water: 350 parts

The above materials are mixed, heated to 100° C., dispersed by using a homogenizer (ULTRA-TURRAX T50 manufactured by IKA Japan), and then dispersed with a pressure discharge Gaulin homogenizer to obtain a release agent particle dispersion liquid in which release agent particles having a volume-average particle diameter of 200 nm are dispersed. Ion-exchanged water is added to the release agent particle dispersion liquid to adjust the solid content to 20%, thereby obtaining a release agent particle dispersed liquid (W1).

### Preparation of Colorant Particle Dispersion Liquid (Y1)

Yellow pigment (C.I. Pigment Yellow 180): 50 parts
Anionic surfactant (manufactured by DKS Co., Ltd., NEOGEN RK): 5 parts
Ion-exchanged water: 195 parts

The above materials are mixed and dispersed with a high-pressure impact disperser (Ultimaizer HJP30006, Sugino Machine Limited) for 60 minutes to obtain a colorant particle dispersion liquid (K1) having a solid content of 20%.

### Preparation of Colorant Particle Dispersion Liquid (C1)

Cyan pigment (Pigment Blue 15:3, Dainichiseika Color & Chemicals Mfg. Co., Ltd.): 50 parts
Anionic surfactant (manufactured by DKS Co., Ltd., NEOGEN RK): 5 parts
Ion-exchanged water: 195 parts

The above materials are mixed and dispersed with a high-pressure impact disperser (Ultimaizer HJP30006, Sugino Machine Limited) for 60 minutes to obtain a colorant particle dispersion liquid (C1) having a solid content of 20%.

### Preparation of Colorant Particle Dispersion Liquid (M1)

Magenta pigment (Pigment Red 122, DIC Corporation): 50 parts
Anionic surfactant (manufactured by DKS Co., Ltd., NEOGEN RK): 5 parts
Ion-exchanged water: 195 parts

The above materials are mixed and dispersed with a high-pressure impact disperser (Ultimaizer HJP30006, Sugino Machine Limited) for 60 minutes to obtain a colorant particle dispersion liquid (M1) having a solid content of 20%.

### Preparation of Yellow Toner Particles (Y1)

Ion-exchanged water: 200 parts
Amorphous polyester resin dispersion liquid (A1): 150 parts
Crystalline polyester resin dispersion liquid (C1): 10 parts
Release agent particle dispersion liquid (W1): 10 parts
Colorant particle dispersion liquid (Y1): 15 parts
Anionic surfactant (TaycaPower): 2.8 parts

The above materials are placed in a round-bottom flask made of stainless steel, and 0.1 N nitric acid is added thereto to adjust the pH to 3.5. Then, an aqueous polyaluminum chloride solution prepared by dissolving 2 parts of polyaluminum chloride (manufactured by Oji Paper Co., Ltd., 30% powder product) in 30 parts of ion-exchanged water is added thereto. After dispersion is performed at 30° C. using a homogenizer (ULTRA-TURRAX T50, manufactured by IKA), the resulting product is heated to 45° C. in a heating oil bath and kept until the volume-average particle diameter reaches 4.9 μm. Subsequently, 60 parts of the amorphous polyester resin dispersion liquid (A1) is added thereto, and the mixture is kept for 30 minutes. Subsequently, when the volume-average particle diameter reaches 5.2 μm, 60 parts of the amorphous polyester resin dispersion liquid (A1) is further added thereto, and the mixture is kept for 30 minutes. Subsequently, 20 parts of an aqueous solution of 10% NTA (nitrilotriacetic acid) metal salt (Chelest 70, manufactured by Chelest Corporation) is added, and an aqueous 1 N sodium hydroxide solution is added thereto to adjust the pH to 9.0. Subsequently, 1 part of an anionic surfactant (TaycaPower) is added thereto, and the resulting mixture is heated to 85° C. under stirring and kept for 5 hours. Subsequently, the resulting product is cooled to 20° C. at a rate of 20° C./min. Subsequently, the resulting product is filtered, sufficiently washed with ion-exchanged water, and dried to obtain yellow toner particles (Y1) having a volume-average particle diameter of 5.7 μm and an average circularity of 0.971.

### Preparation of Cyan Toner Particles (C1)

Cyan toner particles (C1) are obtained in the same manner as in the preparation of the yellow toner particles (Y1), except that the colorant particle dispersion liquid (Y1) is changed to the colorant particle dispersion liquid (C1).

### Preparation of Magenta Toner Particles (M1)

Magenta toner particles (M1) are obtained in the same manner as in the preparation of the yellow toner particles (Y1), except that the colorant particle dispersion liquid (Y1) is changed to the colorant particle dispersion liquid (M1).

### Preparation of Toner

An external additive is externally added to each of the toner particles to obtain a yellow toner (Y1), a cyan toner (C1), and a magenta toner (M1).

### Ferrite Particles

Preparation of Ferrite Particles Fe₂O₃, 587 parts of Mn(OH)₂, and 96 parts of Mg(OH)₂, and calcination is performed at a temperature of 900° C. for 4 hours. The calcined product, 6.6 parts of polyvinyl alcohol, 0.5 parts of polycarboxylic acid serving as a dispersing agent, and zirconia beads having a medium size of 1 mm are charged into water, and are pulverized and mixed over 30 minutes with a sand mill to obtain a dispersion liquid. The volume-average particle diameter of the particles in the dispersion liquid is 1.5 μm.

The dispersion liquid as a raw material is granulated and dried using a spray dryer to obtain granules having a volume-average particle diameter of 35 μm. Subsequently, main firing is performed in an oxygen-nitrogen mixed atmosphere having an oxygen partial pressure of 1% using an electric furnace at a temperature of 1350° C. for 4 hours. Then, heating is performed in the air at a temperature of 900° C. for 3 hours to obtain fired particles. The fired particles are crushed and classified to obtain ferrite particles (1) having a volume-average particle diameter of 35 μm. The arithmetic surface roughness Ra (JIS B0601:2001) of the surfaces of the ferrite particles (1) is 0.7 μm.

### Preparation of Ferrite Particles (2)

Ferrite particles (2) having a volume-average particle diameter of 35 μm are obtained in the same manner as in the preparation of the ferrite particles 1, except that the firing is performed at 1400° C. for 6 hours in the main firing process. The arithmetic surface roughness Ra (JIS B0601:2001) of the surfaces of the ferrite particles (2) is 0.5 μm.

### Preparation of Ferrite Particles (3)

Ferrite particles (3) having a volume-average particle diameter of 35 μm are obtained in the same manner as in the preparation of the ferrite particles 1, except that the process with a sand mill is extended to 1 hour and the volume-average particle diameter of the particles in the dispersion liquid is set to 1.0 μm. The arithmetic surface roughness Ra (JIS B0601:2001) of the surfaces of the ferrite particles (3) is 1.1 μm.

### Silica Particles

### Preparation of Silica Particles (1)

Commercially available silica particles (spherical sol-gel silica, X24-9163A manufactured by Shin-Etsu Chemical Co., Ltd., average particle diameter 120 nm) are provided and used as silica particles (1).

### Preparation of Silica Particles (2)

Commercially available silica particles (fumed silica, Silfil NHM-4N manufactured by Tokuyama Corporation, average particle diameter 90 nm) are provided and used as silica particles (2).

### Preparation of Silica Particles (3)

Commercially available silica particles (spherical sol-gel silica, TG-C413 manufactured by Cabot Corporation, average particle diameter 50 nm) are provided and used as silica particles (3).

### Preparation of Silica Particles (4)

Commercially available silica particles (spherical sol-gel silica, TG-C6020 manufactured by Cabot Corporation, average particle diameter 200 nm) are provided and used as silica particles (4).

### Preparation of Silica Particles (5)

Commercially available silica particles (fumed silica, TG-3110 manufactured by Cabot Corporation, average particle diameter 12 nm) are provided and used as silica particles (5).

### Silica Particles (6)

### Preparation of Silica Particles (6)

### Preparation Process (Preparation of Alkali Catalyst Solution)

Into a glass reaction vessel equipped with a stirrer, a dropping nozzle, and a thermometer, 200 parts of methanol and 36 parts of 10% ammonia water are placed, and stirring is performed to obtain an alkali catalyst solution. The ammonia content in the alkali catalyst solution is 0.73 mol/L.

### Particle Generation Process (Preparation of Silica Particle Suspension)

### Granulation Process

The temperature of the alkali catalyst solution is adjusted to 50° C., and nitrogen purging is performed on the alkali catalyst solution. Then, tetramethoxysilane (TMOS) and ammonia water having a concentration of 3.7% are added dropwise at flow rates of 4 parts/min and 2.4 parts/min, respectively, while the alkali catalyst solution is stirred at 120 rpm.

Two minutes after the start of the supply of tetramethoxysilane and ammonium water, the supply of tetramethoxysilane and ammonium water is simultaneously stopped. When the supply of tetramethoxysilane and ammonium water is stopped, the amount of tetramethoxysilane supplied is 0.0063 mol/mol relative to the number of moles of alcohol added to the reaction vessel in the preparation process. After the stop of the supply of tetramethoxysilane and ammonia water, stirring is performed for 10 minutes and then the supply of tetramethoxysilane and ammonia water is restarted. The flow rates of tetramethoxysilane and ammonia water are set to 4 parts/min and 2.4 parts/min, respectively.

The amounts of tetramethoxysilane and 3.7% ammonia water added in all the processes including the first supply process and the second supply process are 90 parts and 54 parts, respectively.

After completion of the dropwise addition of tetramethoxysilane and 3.7% ammonia water, a suspension of silica particles is obtained.

### Removal of Solvent and Drying

The solvent of the obtained suspension of silica particles is distilled under heating to remove 150 parts of the solvent. Then, 150 parts of pure water is added thereto, and drying is performed with a freeze dryer to obtain silica particles before hydrophobic treatment.

### Hydrophobic Treatment for Silica Particles

Seven parts of hexamethyldisilazane is added to 35 g of the silica particles before hydrophobic treatment and reacted at 150° C. for 2 hours to obtain silica particles whose surfaces are subjected to hydrophobic treatment (silica particles (6)).

The volume-average particle diameter measured for the obtained silica particles (6) is 220 nm.

### Example 1

### Production of Carrier

### First Step

Cyclohexyl methacrylate/methyl methacrylate copolymer (copolymerization ratio 95 mol:mol): 1 part
Silica particles (1): 0.0005 parts
Toluene: 5 parts

The above materials and glass beads (diameter: 1 mm, the same amount as toluene) are charged into a sand mill and stirred at a rotational speed of 1200 rpm for 30 minutes to obtain a resin layer-forming solution (1).

Into a vacuum degassing kneader, 100 parts of the ferrite particles (1) are charged, and the resin layer-forming solution (1) is further charged. Heating and reduction in pressure are performed over 30 minutes under stirring at 40 rpm, and toluene is distilled off to coat the ferrite particles (1) with the resin. Subsequently, fine powder and coarse powder are removed using an elbow jet to obtain a first coated carrier (1).

### Second Step

Cyclohexyl methacrylate/methyl methacrylate copolymer (copolymerization ratio 95 mol:5 mol): 2 parts
Silica particles (1): 0.05 parts
Toluene: 10 parts

The above materials and glass beads (diameter: 1 mm, the same amount as toluene) are charged into a sand mill and stirred at a rotational speed of 1200 rpm for 30 minutes to obtain a resin layer-forming solution (2).

Into a vacuum degassing kneader, the first coated carrier (1) is charged, and the resin layer-forming solution (2) is further charged. Heating and reduction in pressure are performed over 30 minutes under stirring at 40 rpm. Subsequently, fine powder and coarse powder are removed using an elbow jet to obtain a carrier (1).

### Production of Developer

The carrier (1) and the yellow toner (Y1) are charged into a V-blender at a mixing ratio of carrier:toner=100:10 (mass ratio) and stirred for 20 minutes to obtain a yellow developer.

A cyan developer is obtained in the same manner as described above, except that the yellow toner (Y1) is changed to the cyan toner (C1).

A magenta developer is obtained in the same manner as described above, except that the yellow toner (Y1) is changed to the magenta toner (M1).

### Example 2

A developer is obtained in the same manner as in Example 1, except that the amount of silica particles (1) added in the second step of the method for producing a carrier is changed to 0.005 parts.

### Example 3

A developer is obtained in the same manner as in Example 1, except that the amount of silica particles (1) added in the second step of the method for producing a carrier is changed to 0.1 parts.

### Example 4

A developer is obtained in the same manner as in Example 1, except that the amount of silica particles (1) added in the first step of the method for producing a carrier is changed to 0.005 parts and the amount of silica particles (1) added in the second step of the method for producing a carrier is changed to 0.005 parts.

### Example 5

A developer is obtained in the same manner as in Example 1, except that the amount of silica particles (1) added in the first step of the method for producing a carrier is changed to 0.0001 parts and the amount of silica particles (1) added in the second step of the method for producing a carrier is changed to 0.1 parts.

### Example 6

A developer is obtained in the same manner as in Example 1, except that the silica particles (1) are changed to the silica particles (2) in the method for producing a carrier.

### Example 7

A developer is obtained in the same manner as in Example 1, except that the silica particles (1) are changed to the silica particles (3) in the method for producing a carrier.

### Example 8

A developer is obtained in the same manner as in Example 1, except that the silica particles (1) are changed to the silica particles (4) in the method for producing a carrier.

### Example 9

A developer is obtained in the same manner as in Example 1, except that the amount of silica particles (1) added in the first step of the method for producing a carrier is changed to 0.005 parts and the amount of silica particles (1) added in the second step of the method for producing a carrier is changed to 1 part.

### Example 10

A developer is obtained in the same manner as in Example 1, except that the amount of silica particles (1) added in the first step of the method for producing a carrier is changed to 0.005 parts and the amount of silica particles (1) added in the second step of the method for producing a carrier is changed to 2 parts.

### Example 11

A developer is obtained in the same manner as in Example 1, except that the amount of silica particles (1) added in the first step of the method for producing a carrier is changed to 0.005 parts and the amount of silica particles (1) added in the second step of the method for producing a carrier is changed to 0.006 parts.

### Example 12

A developer is obtained in the same manner as in Example 1, except that the amount of silica particles (1) added in the second step of the method for producing a carrier is changed to 0.025 parts.

### Example 13

A developer is obtained in the same manner as in Example 1, except that the amount of silica particles (1) added in the second step of the method for producing a carrier is changed to 0.008 parts.

### Example 14

A developer is obtained in the same manner as in Example 1, except that the amount of silica particles (1) added in the second step of the method for producing a carrier is changed to 0.012 parts.

### Example 15

A developer is obtained in the same manner as in Example 1, except that the amount of silica particles (1) added in the first step of the method for producing a carrier is changed to 0.005 parts and the amount of silica particles (1) added in the second step of the method for producing a carrier is changed to 0.9 parts.

### Example 16

A developer is obtained in the same manner as in Example 1, except that the amount of silica particles (1) added in the first step of the method for producing a carrier is changed to 0.005 parts and the amount of silica particles (1) added in the second step of the method for producing a carrier is changed to 1.1 parts.

### Example 17

A developer is obtained in the same manner as in Example 1, except that the amount of silica particles (1) added in the first step of the method for producing a carrier is changed to 0.0002 parts and the amount of silica particles (1) added in the second step of the method for producing a carrier is changed to 0.07 parts.

### Example 18

A developer is obtained in the same manner as in Example 1, except that the amount of silica particles (1) added in the first step of the method for producing a carrier is changed to 0.0001 parts and the amount of silica particles (1) added in the second step of the method for producing a carrier is changed to 0.05 parts.

### Example 19

A developer is obtained in the same manner as in Example 1, except that the ferrite particles (1) are changed to the ferrite particles (2) in the method for producing a carrier.

### Example 20

A developer is obtained in the same manner as in Example 1, except that the ferrite particles (1) are changed to the ferrite particles (3) in the method for producing a carrier.

### Example 21

A developer is obtained in the same manner as in Example 1, except that the amount of cyclohexyl methacrylate/methyl methacrylate copolymer added in the first step of the method for producing a carrier is changed to 0.5 parts and the amount of cyclohexyl methacrylate/methyl methacrylate copolymer added in the second step of the method for producing a carrier is changed to 1 part.

### Example 22

A developer is obtained in the same manner as in Example 1, except that the amount of cyclohexyl methacrylate/methyl methacrylate copolymer added in the first step of the method for producing a carrier is changed to 1 part and the amount of cyclohexyl methacrylate/methyl methacrylate copolymer added in the second step of the method for producing a carrier is changed to 4.5 parts.

### Comparative Example 1

A developer is obtained in the same manner as in Example 1, except that the amount of silica particles (1) added in the first step of the method for producing a carrier is changed to 0.1 parts.

### Comparative Example 2

A developer is obtained in the same manner as in Example 1, except that the amount of silica particles (1) added in the first step of the method for producing a carrier is changed to 0.1 parts and silica particles are not added in the second step.

### Comparative Example 3

A developer is obtained in the same manner as in Example 1, except that the amount of silica particles (1) added in the first step of the method for producing a carrier is changed to 0.1 parts and the amount of silica particles (1) added in the second step is changed to 0.2 parts.

### Comparative Example 4

A developer is obtained in the same manner as in Example 1, except that the silica particles (1) are changed to the silica particles (5) in the method for producing a carrier.

### Comparative Example 5

A developer is obtained in the same manner as in Example 1, except that the silica particles (1) are changed to the silica particles (6) in the method for producing a carrier.

### Comparative Example 6

A developer is obtained in the same manner as in Example 1, except that the amount of silica particles (1) added in the first step of the method for producing a carrier is changed to 0.1 parts and the amount of silica particles (1) added in the second step is changed to 2.5 parts.

### Comparative Example 7

A developer is obtained in the same manner as in Example 1, except that the amount of silica particles (1) added in the second step of the method for producing a carrier is changed to 0.0001 parts.

### Comparative Example 8

A developer is obtained in the same manner as in Example 1, except that the amount of silica particles (1) added in the first step of the method for producing a carrier is changed to 0.0001 parts and the amount of silica particles (1) added in the second step is changed to 0.11 parts.

### Evaluation of White Spot

A developing device of a modified apparatus “DocuCentre Color 400 (manufactured by Fuji Xerox Co., Ltd.)” is filled with the developer obtained in each of Examples. A test is performed in which an image with a chart having an area coverage of 1% is printed on 10,000 sheets of J paper (manufactured by Fuji Xerox Co., Ltd.) of A4 size over 10 days using a DocuCentre Color 400 (manufactured by Fuji Xerox Co., Ltd.) in an environment of 28.5° C. and 85% RH. After the image is printed on a total of 10,000 sheets, an image having an area coverage of 30% is printed on 500 sheets. Subsequently, a tertiary color (process black) entire solid image having a toner mass per area of 9.8 g/cm² and a secondary color patch having a toner mass per area of 6.5 g/cm² are printed as image samples on ten sheets of 45 paper (manufactured by Ricoh Co., Ltd., basis weight: 52 gsm) of A4 size.

The second image sample of the image samples (hereafter, simply referred to as image samples) on which the tertiary color entire solid image and the secondary color patch have been printed is visually checked, and the evaluation of white spots is performed based on the following evaluation criteria. Note that A to C are defined as being acceptable.

A: There is no problem in image quality.
B: Slight unevenness is observed around the tertiary color patch.
C: Slight unevenness is observed around the secondary color patch in addition to the tertiary color patch.
D: White spots are observed in the tertiary color patch.
E: White spots are observed around the secondary color patch in addition to the tertiary color patch.

### Evaluation of Fogging

The image density E in a background portion of the first image sample obtained in the evaluation of white spots is measured with an image densitometer X-Rite 938 (manufactured by X-Rite Inc.). The image sample is also visually checked. Furthermore, tape transfer evaluation on the photoreceptor is performed.

Fogging is evaluated based on the following evaluation criteria using the image density E in the background portion, the visual check, and the results of tape transfer evaluation. Note that A to C are defined as being acceptable.

A: The image density E in the background portion is less than 0.015, fogging cannot be visually recognized, and there is no problem in the tape transfer on the photoreceptor and image quality.
B: The image density E in the background portion is 0.015 or more and less than 0.03, fogging cannot be visually recognized, and fogging slightly occurs in the tape transfer on the photoreceptor, but there is no problem in image quality.
C: The image density E in the background portion is 0.03 or more and less than 0.05, and fogging is clearly observed in the tape transfer on the photoreceptor.
D: The image density E in the background portion is 0.05 or more, and fogging is clearly observed on the image.

### Evaluation of Carrier Resistance Retention

After the evaluation of white spots, the developer is taken out from the developing device of the modified apparatus “DocuCentre Color 400 (manufactured by Fuji Xerox Co., Ltd.)”. The toner is removed from the taken-out developer by air blowing to separate a carrier (hereafter referred to as a used carrier). The electric resistance of the carrier is measured using a super megohmmeter DSM-8104 manufactured by Hioki E. E. Corporation. Then, the electric resistance of the same carrier (unused carrier) as used in the production of the taken-out developer is measured.

The percentage of the electrical resistance of the used carrier relative to the electrical resistance of the unused carrier is calculated, and the carrier resistance retention is evaluated based on the following evaluation criteria.

A: 90% or more and 100% or less
B: 80% or more and less than 90%
C: 70% or more and less than 80%
D: 65% or more and less than 70%
E: less than 65%

TABLE 1

| | First step | | | | Second step | | | | | | | | |
|---|---|---|---|---|---|---|---|---|---|---|---|---|---|
| | | | Silica particles | | Silica particles | | | | | | | | |
| | | | | Average | | Average | | | | Thickness | | | |
| | Ferrite particles | | | particle | | particle | | | | of resin | | | |
| | | Ra | | diameter | | diameter | | | | layer | Resistance | | White |
| | Type | (μm) | Type | (nm) | Type | (nm) | Ratio Si1 | Ratio Si2 | Si1/Si2 | (μm) | retention | Fogging | spot |
| Example 1 | (1) | 0.7 | (1) | 120 | (1) | 120 | 0.05 | 0.0005 | 100 | 0.9 | A | A | A |
| Example 2 | (1) | 0.7 | (1) | 120 | (1) | 120 | 0.005 | 0.0005 | 10 | 0.9 | B | A | A |
| Example 3 | (1) | 0.7 | (1) | 120 | (1) | 120 | 0.1 | 0.0005 | 200 | 0.9 | A | B | A |
| Example 4 | (1) | 0.7 | (1) | 120 | (1) | 120 | 0.005 | 0.005 | 1 | 0.9 | A | A | A |
| Example 5 | (1) | 0.7 | (1) | 120 | (1) | 120 | 0.1 | 0.0001 | 1000 | 0.9 | C | B | C |
| Example 6 | (1) | 0.7 | (2) | 90 | (2) | 90 | 0.05 | 0.0005 | 100 | 0.9 | B | A | B |
| Example 7 | (1) | 0.7 | (3) | 50 | (3) | 50 | 0.05 | 0.0005 | 100 | 0.9 | B | A | A |
| Example 8 | (1) | 0.7 | (4) | 200 | (4) | 200 | 0.05 | 0.0005 | 100 | 0.9 | B | A | B |
| Example 9 | (1) | 0.7 | (1) | 120 | (1) | 120 | 1 | 0.005 | 200 | 0.9 | A | C | A |
| Example 10 | (1) | 0.7 | (1) | 120 | (1) | 120 | 2 | 0.005 | 400 | 0.9 | A | C | A |
| Example 11 | (1) | 0.7 | (1) | 120 | (1) | 120 | 0.006 | 0.005 | 1.2 | 0.9 | B | A | B |
| Example 12 | (1) | 0.7 | (1) | 120 | (1) | 120 | 0.25 | 0.0005 | 500 | 0.9 | B | A | B |
| Example 13 | (1) | 0.7 | (1) | 120 | (1) | 120 | 0.008 | 0.0005 | 16 | 0.9 | A | A | A |
| Example 14 | (1) | 0.7 | (1) | 120 | (1) | 120 | 0.012 | 0.0005 | 24 | 0.9 | A | A | A |
| Example 15 | (1) | 0.7 | (1) | 120 | (1) | 120 | 0.9 | 0.005 | 180 | 0.9 | A | B | A |
| Example 16 | (1) | 0.7 | (1) | 120 | (1) | 120 | 1.1 | 0.005 | 220 | 0.9 | A | B | A |

TABLE 2

| | First step | | | | Second step | | | | | | | | |
|---|---|---|---|---|---|---|---|---|---|---|---|---|---|
| | | | Silica particles | | Silica particles | | | | | | | | |
| | | | | Average | | Average | | | | Thickness | | | |
| | Ferrite particles | | | particle | | particle | | | | of resin | | | |
| | | Ra | | diameter | | diameter | | | | layer | Resistance | | White |
| | Type | (μm) | Type | (nm) | Type | (nm) | Ratio Si1 | Ratio Si2 | Si1/Si2 | (μm) | retention | Fogging | spot |
| Example 17 | (1) | 0.7 | (1) | 120 | (1) | 120 | 0.07 | 0.0002 | 350 | 0.9 | C | A | B |
| Example 18 | (1) | 0.7 | (1) | 120 | (1) | 120 | 0.05 | 0.0001 | 500 | 0.9 | C | A | B |
| Example 19 | (2) | 0.5 | (1) | 120 | (1) | 120 | 0.05 | 0.0005 | 100 | 0.9 | C | B | B |
| Example 20 | (3) | 1.1 | (1) | 120 | (1) | 120 | 0.05 | 0.0005 | 100 | 0.9 | C | B | B |
| Example 21 | (1) | 0.7 | (1) | 120 | (1) | 120 | 0.05 | 0.0005 | 100 | 0.4 | B | A | B |
| Example 22 | (1) | 0.7 | (1) | 120 | (1) | 120 | 0.05 | 0.0005 | 100 | 2.5 | B | A | B |
| Comparative | (1) | 0.6 | (1) | 120 | (1) | 120 | 0.05 | 0.1 | 0.5 | 0.9 | D | B | D |
| Example 1 | | | | | | | | | | | | | |
| Comparative | (1) | 0.6 | (1) | 120 | No | — | 0 | 0.1 | 0 | 0.9 | D | B | E |
| Example 2 | | | | | addition | | | | | | | | |
| Comparative | (1) | 0.6 | (1) | 120 | (1) | 120 | 4 | 0.0001 | 40000 | 0.9 | B | E | D |
| Example 3 | | | | | | | | | | | | | |
| Comparative | (1) | 0.6 | (5) | 12 | (5) | 12 | 0.05 | 0.0005 | 100 | 0.9 | D | C | D |
| Example 4 | | | | | | | | | | | | | |
| Comparative | (1) | 0.6 | (6) | 220 | (6) | 220 | 0.05 | 0.0005 | 100 | 0.9 | D | C | D |
| Example 5 | | | | | | | | | | | | | |
| Comparative | (1) | 0.6 | (1) | 120 | (1) | 120 | 2.5 | 0.1 | 25 | 0.9 | B | E | D |
| Example 6 | | | | | | | | | | | | | |
| Comparative | (1) | 0.6 | (1) | 120 | (1) | 120 | 0.0001 | 0.0005 | 0.2 | 0.9 | C | B | D |
| Example 7 | | | | | | | | | | | | | |
| Comparative | (1) | 0.6 | (1) | 120 | (1) | 120 | 0.11 | 0.0001 | 1100 | 0.9 | C | E | D |
| Example 8 | | | | | | | | | | | | | |

The above results show that the carriers of Examples suppress the occurrence of image omission when an image with a low area coverage is continuously formed in a high-temperature and high-humidity environment, and then an image with a high area coverage is formed in a high-temperature and high-humidity environment.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A carrier for developing an electrostatic image, comprising:
a magnetic particle; and
a resin layer with which the magnetic particle is coated and which contains silica particles having an average particle diameter of 50 nm or more and 200 nm or less,
wherein a silicon element ratio Si1 in a region in which a distance from a surface of the resin layer in a direction toward an inside is 0.1 μm or more and 0.2 μm or less and a silicon element ratio Si2 in a region in which a distance from a surface of the magnetic particle in a direction toward the surface of the resin layer is 0.0 μm or more and 0.1 μm or less satisfy formula 1-1 and formula 2-1 below,
0005≤Si1≤2 Formula 1-1
1≤Si1/Si2≤1000. Formula 2-1

2. The carrier for developing an electrostatic image according to claim 1, wherein the ratio Si1 satisfies formula 1-2 below,
0.01≤Si1≤1. Formula 1-2

3. The carrier for developing an electrostatic image according to claim 2, wherein the ratio Si1 and the ratio Si2 satisfy formula 2-2 below,
50≤Si1/Si2≤4000. Formula 2-2

4. The carrier for developing an electrostatic image according to claim 1, wherein the magnetic particle has a surface with an arithmetic surface roughness Ra of 0.2 μm≤Ra≤2 μm.

5. The carrier for developing an electrostatic image according to claim 1, wherein the silica particles have an average particle diameter of 55 nm or more and 150 nm or less.

6. The carrier for developing an electrostatic image according to claim 1, wherein the resin layer has a thickness of 0.3 μm or more and 3.0 μm or less.

7. An electrostatic image developer comprising:
the carrier for developing an electrostatic image according to claim 1; and
a toner for developing an electrostatic image.

8. An image forming method comprising:
charging at least an image holding member;
forming an electrostatic latent image on a surface of the image holding member;
developing the electrostatic latent image formed on the surface of the image holding member using an electrostatic image developer to form a toner image;
transferring the toner image formed on the surface of the image holding member onto a surface of a transfer-receiving medium; and
fixing the toner image,
wherein the electrostatic image developer is the electrostatic image developer according to claim 7.
